(19) United States
(12) Patent Application Publication
(10) Pub. No.: US 2026/0257888 A1
(43) Pub. Date: Sep. 3, 2026

(54) READING DEVICE FOR A SHAFT INFORMATION SYSTEM OF AN ELEVATOR SYSTEM, SHAFT INFORMATION SYSTEM, AND ELEVATOR SYSTEM

(71) Applicant: Inventio AG, Hergiswil (CH)

(72) Inventors: Astrid Sonnenmoser, Hochdorf (CH); Simon Zingg, Kloten (CH); David Michel, Rotkreuz (CH); Jean-Philippe Escher, Langnau am Albis (CH)

(21) Appl. No.: 18/715,820

(22) PCT Filed: Dec. 6, 2022
(86) PCT No.: PCT/EP2022/084485

§ 371 Date: Jun. 3, 2024

(30) Foreign Application Priority Data
Dec. 10, 2021 (EP) 21213582.6

(51) Int. Cl. B66B 1/34; B66B 7/12

(52) U.S. Cl. CPC B66B 1/3492; B66B 7/1276

(57) ABSTRACT

A reading device for a shaft information system of an elevator system is coupled to a component of the elevator system that moves along a travel path of the elevator system. The reading device has a reading slot for a strip encoded with shaft information running along the travel path. A dirt capture device is arranged at least near one end of the reading slot, wherein the dirt capture device surrounds the strip at least partially and prevents any dirt particles adhering to the strip from entering the reading slot.

### FIELD

The present invention relates to a reading device for a shaft information system of an elevator system and a shaft information system for an elevator system, along with an elevator system.

### BACKGROUND

An elevator system can have vertically movable components such as a car and a counterweight to the car. The vertically movable components can be guided through a rail system of the elevator system. The rail system thereby prevents lateral movements of the vertically movable components. The vertically movable components can be moved along the rail system from stop to stop by a drive device.

In order for the car to be positioned correctly at the stops, the drive device requires precise position information of the car. The position information can be provided by a shaft information system. For example, a magnetic strip can be arranged parallel to the rail system. A reading device for the magnetic strip can be arranged on the car. Height information can be stored magnetically on the magnetic strip, which height information can be read by the reading device using at least one magnetic reading head.

The height information read out can be compared with stored height information of the stops. If the car has approached the desired stop up to a predefined distance, the drive device can initiate a braking process and bring the car to a standstill exactly at the stop. Other functionalities can also be controlled or triggered based upon the height information read out, such as initiating an opening process of car doors shortly before reaching a stop or compensating for level differences while the car is waiting at a stop.

Due to the magnetic strip, the shaft information system has high material costs, among other things.

The permanently magnetized magnetic strip can be replaced by a locally magnetizable strip. In the band, the height information can be encoded by locally magnetizable regions. The strip can be made of a textile material, for example. The magnetizable regions can be formed by metallizing the strip. The regions can be temporarily magnetized locally by a magnetizing device on the reading device and read out by one or more magnetic reading heads of the reading device.

WO 2021/175421 A1, for example, describes such a measuring strip for elevator systems.

The magnetizing device can have at least one magnet, past which the magnetizable regions are guided. The magnet can be a permanent magnet, for example. The magnet can attract magnetic or magnetizable dirt particles adhering to the strip or drawn into the magnetizing device by a draft of air. In extreme cases, the dirt particles could accumulate on the magnet and cause friction between the reading device and the strip, for example. The friction can in turn cause abrasion on the strip or on the magnetizable regions and/or on the reading device, which in turn can lead to more magnetic or magnetizable particles.

### SUMMARY

Among other things, there may be a need for a shaft information system with improved properties—in particular, for example, less sensitivity to dirt.

Such a need can be met by a reading device for a shaft information system, along with a shaft information system for an elevator system and an elevator system equipped therewith according to the advantageous embodiments defined and described in the description.

With the approach presented here, at least a large proportion of the dirt particles are removed from the strip or even from the air before the strip enters the reading device. This removes the dirt particles before they can accumulate on the magnetizing device. By removing the dirt particles, safe operation of the shaft information system over a long period of time can be ensured.

According to one aspect of the invention, a reading device for a shaft information system of an elevator system is presented, wherein the reading device can be coupled to a component of the elevator system that moves along a travel path of the elevator system, and has a reading slot for a strip encoded with shaft information running along the travel path, wherein a dirt capture device is arranged at least at or near one end of the reading slot, wherein the dirt capture device is designed to surround the strip at least partially and to prevent any dirt particles adhering to the strip from entering the reading slot.

According to a further aspect of the invention, a shaft information system for an elevator system is presented, wherein the shaft information system has a strip tensioned vertically along a travel path of the elevator system and encoded with shaft information, and a reading device, coupled to a moving component of the elevator system, according to the first aspect of the invention, wherein the reading device is aligned with the strip, and the strip runs through the reading slot of the reading device, wherein the dirt capture device at least partially surrounds the strip and prevents dirt particles adhering to the strip from entering the reading slot.

According to still another aspect of the invention, an elevator system is presented, which has a moving component that can be displaced along a travel path and a shaft information system according to an embodiment of the second aspect of the invention, the reading device of which is coupled to the component.

An elevator system can be a passenger transport system. Moving components of the elevator system can be cars and counterweights. The elevator system can have at least one counterweight per car. In order to position the car correctly, position information of the car is required. A shaft information system can provide this position information, among other things. The position information can represent a current height of the car along a travel path of the elevator system. The speed and acceleration of the car can be derived from a sequence of position information.

The shaft information system can consist of a measurement scale and a reading device for reading the measurement scale at the position of the moving component. The reading device can be coupled to the moving components for this purpose. In particular, the reading device can be mounted on the car. The reading device can provide the position information of this moving component. The measurement scale can be arranged parallel to the travel path and extend over the entire travel path.

The measurement scale can be an encoded strip. The strip can be arranged in a fixed position. The strip can be tensioned parallel to the travel path of the elevator system. The position information can be encoded in the measurement scale. Further shaft information can also be encoded in the strip. The position information can be encoded incrementally and/or absolutely in the measurement scale. With incremental encoding, indistinguishable increments are encoded in the measurement scale. The increments can all be the same. The position information can be read out by counting the increments starting from a reference point. With absolute encoding, subsections of the measurement scale are individually encoded and distinguishable. The position information can be read directly by decoding the code of the subsection and is unique at each position. The absolute encoding can be binary, for example. The position information can also be encoded as a mixed form, in which a plurality of reference points along the measurement scale are encoded absolutely, and the subsections between the reference points are encoded incrementally.

In particular, the encoded strip can be a strip with a magnetizable code. The strip can be made of a textile material, for example. The strip can have a magnetically readable encoding. The magnetically readable encoding can consist, for example, of magnetizable regions. The strip can have non-magnetizable regions between the magnetizable regions. Particularly in the case of absolute encoding, the regions can have different length expansions and/or width expansions. The regions can be arranged at different lateral and axial positions of the strip.

The reading device can read the strip and provide the position information. In particular, the reading device can read the strip magnetically. For this purpose, the reading device can have at least one reading head, past which the strip is guided. The reading head can read the encoding of the strip and map the position information in an electrical signal. To read the magnetizable strip, the magnetizable regions in the reading device can be magnetized locally and briefly. For this purpose, the reading device can have at least one magnet that magnetizes the regions before or while they pass the reading head. In particular, the reading device can have two pairs of magnets in front of and behind the reading head in order to be able to magnetize the regions in front of the reading head in both directions of movement. The magnet can be a permanent magnet or an electromagnet.

The strip can run through a recess in the reading device. The recess can be described as a reading slot. The recess can have a larger cross-sectional area than the strip. In this way, the strip can be moved freely or without contact through the reading slot. The reading slot can be completely surrounded by the reading device. The strip can then be fastened to an upper end and a lower end of the travel path. For example, the strip can be anchored at the upper end and, by a weight and/or a spring, tensioned at the lower end. From a length of more than 250 meters, for example, the strip can be stabilized by at least one stabilizer. Alternatively, the reading slot can be open on one side or be a groove in the reading device. The strip can then be fastened to the side of the rail system, for example. The strip can be continuous or fastened to a plurality of support points.

A dirt capture device can be arranged substantially in the extension of the reading slot. The dirt capture device can have a cross-sectional area that is substantially identical to that of the reading slot. The dirt capture device can surround the strip on at least two sides. The cross-sectional area can be slightly smaller than the reading slot.

Dirt particles adhering to the strip can be moved away by the dirt capture device—particularly at right angles to the strip—in order to prevent them from entering the reading slot.

The dirt capture device can be designed to remove the dirt particles from the strip at least partially without contact. Alternatively or additionally, the dirt capture device can be designed to contact the strip at least in certain regions in order to remove the dirt particles from the strip at least partially by contact. The dirt capture device can contact the strip in certain regions. The dirt particles can be removed by contact where the dirt capture device contacts the strip. The dirt particles can be removed without contact where the dirt capture device does not contact the strip. Friction between the dirt capture device and the strip can be avoided by contactless removal.

The dirt capture device can have at least one magnet for attracting or repelling magnetic and/or magnetizable dirt particles. Using at least one magnet, the dirt particles can be removed without contact. The magnet can be a permanent magnet or an electromagnet. An electromagnet can be demagnetized in order to repel attracted dirt particles. The magnet can also be arranged in a roller that rolls on the strip. The magnet can, for example, be arranged rigidly inside the roller in order to directly again repel any dirt particles picked up on a side facing away from the strip.

The dirt capture device can have at least one scraper for scraping off the dirt particles. A scraper can be a flexible lip or a solid block. The scraper can contact the strip and can be pressed against the strip with a contact pressure. In particular, the scraper can be aligned in a manner inclined to the main direction of extension of the strip, in order to scrape off the dirt particles at the side.

The dirt capture device can have at least one brush for brushing off the dirt particles. A brush can have bristles and/or hairs. The bristles and/or hairs can contact the strip and perform a relative movement to the strip. Bristles can brush off the dirt particles through a mechanical cleaning action. Hair can attract dirt particles electrostatically. The brush can be designed to be rigid or as a roller. In particular, a roller brush can have an axis of rotation inclined to the main direction of extension of the strip. The inclined position causes the roller brush to rotate if the reading device is moved along the strip. The dirt particles are brushed off to the side by the rotation. The brush can also be driven by an actuator. For example, the roller brush can be set in rotation by a motor.

The dirt trapping device can have at least one adhesion-promoting or adhesive component for binding the dirt particles. The adhesion-promoting component can be designed so that dirt particles adhere to the component at least temporarily. Adhesion can be caused, for example, by macroscopic or microscopic electrostatic forces. An adhesive component can, for example, be an open, permanently adhesive film. The adhesive component can also be an elastomer, such as a silicone. The adhesive component can be designed to be in contact with the strip, e.g., as a roller rolling on the strip, or it can be designed to be contactless-for example, as a trap for held dirt particles. The adhesive component can permanently bind dirt particles into a matrix of the adhesive component.

The dirt capture device can have at least one suction device for suctioning away the dirt particles. A suction device can generate an air flow along a surface of the strip by means of a vacuum. The air flow can entrain the dirt particles and remove them from the strip. The air flow can displace the dirt particles into a filter, for example.

The dirt capture device can have at least one blowing device for blowing off the dirt particles. A blowing device can generate an air flow along a surface of the strip by means of an overpressure. The air flow can entrain the dirt particles and remove them from the strip. The air flow can, for example, be aligned transversely to the main direction of extension. The dirt particles can be blown off to the side by the air flow.

The dirt capture device can have at least one capacitor electrode for electrostatically attracting or repelling the dirt particles. A capacitor electrode can be an electrically conductive surface. The capacitor electrode can be arranged at a distance from the strip and substantially parallel to the strip. An electrical potential difference can be set between the capacitor electrode and the magnetizable regions. The regions then act as the second electrode of a capacitance. An electric field forms between the regions and the capacitor electrode. The electric field can exert a force on the dirt particles and repel the dirt particles from the strip and draw them towards the capacitor electrode.

The dirt capture device can protrude over the housing of the reading device. The dirt capture device can be arranged at least partially outside the housing. The dirt capture device can be connected to the housing via an interface. The interface can, for example, enable a positive connection between the dirt capture device and the housing in order to ensure the alignment of the dirt capture device on the strip or reading slot. The dirt capture device can be an inlet component and/or outlet component of the reading slot.

The dirt capture device can be replaceable. For example, the old dirt capture device can be removed from the reading device, opened, and removed from the strip. A new dirt capture device can be opened, placed around the strip, and connected to the reading device.

It should be noted that some of the possible features and advantages of the invention are described herein with reference to different embodiments of methods on the one hand, and of devices on the other. A person skilled in the art will recognize that the features can be suitably combined, adapted, or exchanged in order to arrive at further embodiments of the invention.

Embodiments of the invention will be described below with reference to the accompanying drawing, wherein neither the drawing nor the description are intended to be interpreted as limiting the invention.

### DESCRIPTION OF THE DRAWINGS

FIG. 1 shows a representation of a shaft information system according to an exemplary embodiment of the invention.

The figure is merely schematic and not to scale. The same reference signs indicate the same or equivalent features.

### DETAILED DESCRIPTION

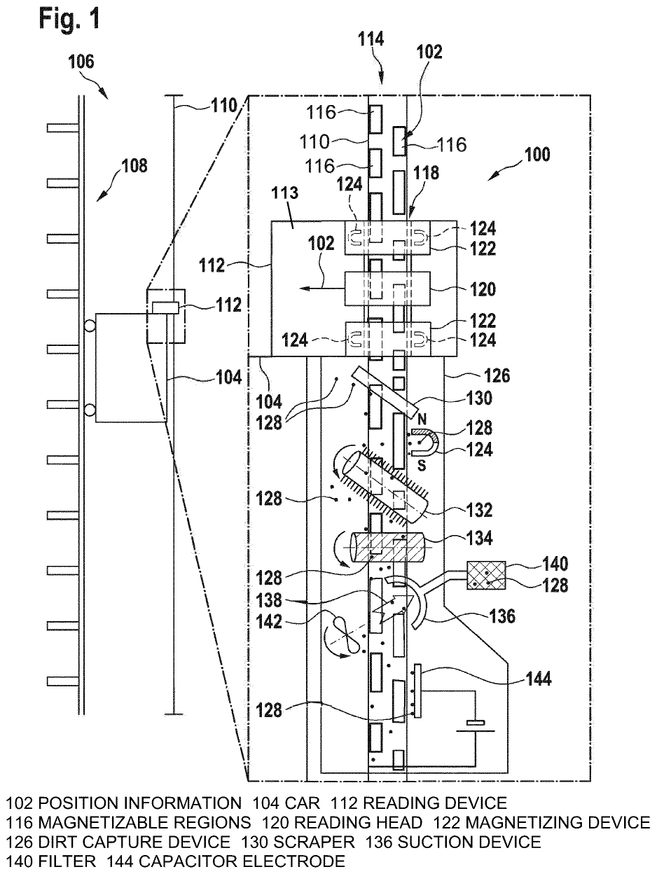

FIG. 1 shows a representation of a shaft information system 100 according to an exemplary embodiment. The shaft information system 100 is designed to provide position information 102 about a moving component 104 of an elevator system 106. The position information 102 represents a current position of the moving component 104 on a travel path 108 of the moving component 104. A speed and an acceleration of the moving component 104 can be derived from the position.

Here, the moving component 104 is a car 104 of the elevator system 106, but can also, for example, be a counterweight of the elevator system 106.

The shaft information system 100 consists of a strip 110 arranged along the travel path 108 and encoded with the position information 102, and a reading device 112 for reading out the position information 102. The strip 110 is a measurement scale that is read out by the reading device 112. Here, the strip 110 is a locally magnetizable textile strip. The strip 110 is stationary and anchored substantially parallel to the travel path 108. For example, the strip 110 is tensioned vertically in an elevator shaft of the elevator system 106.

For example, the strip 110 has a track 114 running longitudinally along the strip 110. In the region of the track 114, the strip 110 has a sequence of magnetizable regions 116. The regions 116 can be of different lengths. In the magnetizable regions 116, a magnetizable metal layer can be applied to a non-magnetizable carrier material of the strip 110.

The reading device 112 has a housing 113 that is connected to the moving component 104 and is moved along the strip 110 when the moving component 104 is moved along the travel path 108. The strip 110 passes through a reading slot 118 formed in the housing 113 of the reading device 112 during the movement of the moving component 104 and the reading device 112. The reading slot 118 has a slightly larger cross-section than the strip 110.

The reading device 112 has at least one reading head 120 for reading the position information 102. The reading head 120 is arranged in the region of the reading slot 118. The reading head 120 is a magnet-sensitive reading head 120 for reading the at least temporarily magnetized strip 110. The reading device 112 can have at least one reading head 120. The reading head 120 reads the encoded position information 102 from the strip 110 located in front of the reading head 120 and maps the position information 102 in an electrical signal. The position information 102 can be encoded or decoded and mapped as height information in the electrical signal.

So that the strip 110 can be made readable, the reading device 112 has a magnetizing device 122. The magnetizing device 122 is also arranged in the region of the reading slot 118. The magnetizing device 122 magnetizes the magnetizable regions 116 at least briefly. In particular, a magnetization of the regions 116 is refreshed each time the strip 110 is moved past the magnetizing device 122 during a movement of the moving component 104. For magnetization, the magnetizing device 122 has at least one strong magnet 124. In particular, the magnetizing device has two magnets 124 arranged on opposite sides of the strip. The magnet can be a permanent magnet 124 or an electromagnet 124. A magnetic field of the magnet 124 causes elementary magnets in atoms of the regions 116 to align themselves in the same direction, at least briefly, and thus themselves form a magnet with an associated magnetic field. Where the strip 110 has no magnetizable regions 116, there are no alignable atoms, and, consequently, no independent magnetic field is formed between the regions 116.

The reading head 120 detects the magnetic field of the elementary magnets formed by the regions 116 and maps the presence or absence or strength and/or alignment of this magnetic field in the electrical signal.

A dirt capture device 126 is arranged at at least one end of the reading slot 118. The dirt capture device 126 is designed to prevent any dirt particles 128 adhering to the strip 110 from entering the reading slot 118. In particular, the dirt capture device 126 is designed to keep magnetic and/or magnetizable dirt particles 128 away from the magnetizing device 122.

Here, the dirt capture device 126 is designed as a protective cap or extension in front of the reading slot 118. As a result, the dirt particles 128 can be removed from the strip 110 before the strip 110 enters the reading slot 118. The dirt capture device 126 protrudes above the reading device 112.

In one exemplary embodiment, the dirt capture device 126 has at least one magnet 124. The magnet 124 does not contact the strip 110. The magnet 124 attracts magnetic and/or magnetizable dirt particles 128 before they enter the reading slot 118. The magnet 124 is in particular a permanent magnet 124. The permanent magnet 124 permanently binds the attracted dirt particles to itself. If the magnet 124 is designed as an electromagnet 124, the dirt particles 128 can be at least partially ejected by briefly switching off or reversing the polarity of the electromagnet 124.

In one exemplary embodiment, the dirt capture device 126 has at least one contacting scraper 130. The scraper 130 glides over a surface of the strip 110 and scrapes the dirt particles 128 off the strip 110. Here, the scraper 130 is aligned in a manner inclined to a longitudinal direction of the strip 110. In this way, the dirt particles 128 are scraped to the side in a transverse direction of the strip 110. In particular, the dirt capture device 126 has two scrapers 130 arranged on opposite sides of the strip 110. The two scrapers 130 remove dirt particles 128 from at least the flat sides of the strip 110.

In one exemplary embodiment, the dirt capture device 126 has at least one brush 132. Bristles and/or hairs of the brush 132 contact the strip 110 and brush the dirt particles 128 off the strip 110 before it enters the reading slot 118. The brush 132 can also be designed as a rotating brush 132. As a result, the hairs and/or bristles can perform a brushing motion over the surface of the strip 110. By means of the brushing motion, the dirt particles 128 are removed particularly effectively.

In one exemplary embodiment, the dirt capture device 126 has at least one adhesion-promoting or adhesive component 134. Here, the adhesive component 134 contacts the surface of the strip 110. The adhesive component 134 is arranged on a roller that rolls on the surface of the strip. The dirt particles 128 adhere to the adhesive component 134 and are removed from the surface by rolling. The adhesive component 134 permanently absorbs the dirt particles 128 in its matrix and binds the dirt particles 128.

In one exemplary embodiment, the adhesive component 134 does not contact the surface. The dirt particles 128 are first removed from the strip 110, e.g., by the scraper 130 or the brush 132, and then adhere permanently to the adhesive component 134. The adhesive component 134 serves as a trap for the dirt particles 128.

In one exemplary embodiment, the dirt capture device 126 has at least one suction device 136. The suction device suctions in air via the surface of the strip 110. The dirt particles 128 are entrained by the resulting air flow 138 and conveyed by the suction device 136 into, for example, a filter 140.

In one exemplary embodiment, the dirt capture device 126 has at least one blowing device 142. The blowing device 142 blows air over the surface. The resulting air flow 138 entrains the dirt particles 128 and thus removes them from the strip 110. The air flow 138 is particularly strong due to the blowing and can be directed well. Even strongly adhering dirt particles 128 can be removed in this way.

In one exemplary embodiment, the dirt capture device 126 has a blowing device 142 and a suction device 136 together. The air flow 138 generated by the blowing device 142 is suctioned in by the suction device 136 with the dirt particles 128. The combination of suction and blowing can prevent further dirt particles 128 from being whirled up from a region surrounding the strip 110.

In one exemplary embodiment, the dirt capture device 126 has at least one capacitor electrode 144. The magnetizable regions 116 form the other electrode of a capacitance. The two electrodes are set to different voltage potentials. The resulting electric field between the regions 116 and the capacitor electrode 144 electrostatically charges the dirt particles 128 and attracts them to the capacitor electrode 144 or repels them from the strip 110.

In other words, a magnetic dirt deflector is presented. With the shaft infosystem with an encoded strip and a magnetic guide, there is a risk that the permanent magnets of the guide strip will attract magnetic particles in the shaft, which can accumulate at the strip entry points and lead to faults or strip defects over time. With the approach presented here, the particles are stopped further out or attracted by suitable means such as magnets. The particles can be retained or attracted in an extension, a cap, or an extended guide rail.

With magnetic guidance, magnets are arranged on the side of the strip in order to magnetize the strip along the length of the sensor. The permanent magnets can attract magnetic particles, which can then accumulate in these zones and cause faults. With the approach presented here, the particles are captured or held outside the sensor. For example, the particles can be attracted away from the side of the strip by an additional magnet.

Finally, it should be noted that terms such as “having,” “comprising,” etc., do not preclude other elements or steps, and terms such as “a” or “one” do not preclude a plurality. Furthermore, it should be noted that features or steps which have been described with reference to one of the above exemplary embodiments may also be used in combination with other features or steps of other exemplary embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. A reading device for a shaft information system of an elevator system, the elevator system having a component that moves along a travel path, the shaft information system including a strip encoded with shaft information and running along the travel path, the reading device comprising:
the reading device having a housing with a reading slot formed therein, wherein when the reading device is connected to the component of the elevator system the strip passes through the reading slot as the component moves; and
a dirt capture device arranged at at least one end of the reading slot, the dirt capture device at least partially surrounding the strip and being adapted to prevent any dirt particles adhering to the strip from entering the reading slot.

15. The reading device according to claim 14 wherein the dirt capture device is adapted to remove the dirt particles from the strip at least partially without contact with the strip before the dirt particles enter the reading slot.

16. The reading device according to claim 14 wherein the dirt capture device contacts the strip at least in predetermined regions of the strip to remove the dirt particles from the strip before the dirt particles enter the reading slot.

17. The reading device according to claim 14 wherein the dirt capture device includes a magnet adapted to attract or repel magnetic and/or magnetizable ones of the dirt particles.

18. The reading device according to claim 14 wherein the dirt capture device includes a scraper adapted to scrape the dirt particles off of the strip.

19. The reading device according to claim 14 wherein the dirt capture device includes a brush adapted to brush the dirt particles off of the strip.

20. The reading device according to claim 14 wherein the dirt capture device includes an adhesion-promoting component adapted to bind the dirt particles thereto thereby removing the dirt particles from the strip.

21. The reading device according to claim 14 wherein the dirt capture device includes a suction device adapted to suction the dirt particles away from the strip.

22. The reading device according to claim 14 wherein the dirt capture device includes a blowing device adapted to blow the dirt particles off of the strip.

23. The reading device according to claim 14 wherein the dirt capture device includes a capacitor electrode adapted to electrostatically attract or repel the dirt particles.

24. The reading device according to claim 14 wherein the dirt capture device protrudes over the housing of the reading device.

25. A shaft information system for an elevator system, the shaft information system comprising:
the reading device according to claim 14 connected to a moving component of the elevator system;
a strip tensioned vertically along a travel path of moving component and being encoded with shaft information; and
wherein the reading device is aligned with the strip such that the strip runs through the reading slot of the reading device, and the dirt capture device at least partially surrounds the strip to prevent dirt particles adhering to the strip from entering the reading slot.

26. An elevator system comprising:
the shaft information system according to claim 25; and
a moving component displaceable along a travel path and having the shaft information system connected thereto.
